(19) United States
(12) Patent Application Publication
(10) Pub. No.: US 2019/0119961 A1
(43) Pub. Date: Apr. 25, 2019

(54) VEHICLE DOOR LOCK DEVICE

(71) Applicant: AISIN SEIKI KABUSHIKI KAISHA, Kariya-shi (JP)

(72) Inventors: Kazunori KOJIMA, Nagoya-shi (JP); Yoshiki ODAKA, Obu-shi (JP); Yusuke YAMADA, Kariya-shi (JP); Naoto NONOMURA, Kariya-shi (JP); Eiji TORII, Aichi-ken (JP)

(73) Assignee: AISIN SEIKI KABUSHIKI KAISHA, Kariya-shi (JP)

(21) Appl. No.: 16/150,838

(22) Filed: Oct. 3, 2018

(30) Foreign Application Priority Data
Oct. 25, 2017 (JP) 2017-206071

(51) Int. Cl. E05B 85/26; E05B 85/04; E05B 85/02

(52) U.S. Cl. CPC E05B 85/26; E05B 85/02; E05B 85/045

(57) ABSTRACT

A vehicle door lock device includes: a latch rotatable between a full-latch position where a vehicle door is retained in a fully closed state by an engagement with a striker, a half-latch position where the door is retained in a half door state by the engagement, and an unlatch position where the striker does not engage with the latch; a pawl rotatable between a state where rotating in a direction to release the engagement is regulated, and a state where the latch does not engage with the pawl; a pawl lever rotatable between a state where rotating in a direction to release the engagement is regulated and a state where the latch does not engage with the pawl lever; a lift lever rotating with the pawl integrally; and an open link capable of pushing the lift lever.

### CROSS REFERENCE TO RELATED APPLICATIONS

This application is based on and claims priority under 35 U.S.C. § 119 to Japanese Patent Application 2017-206071, filed on Oct. 25, 2017, the entire contents of which are incorporated herein by reference.

### TECHNICAL FIELD

This disclosure relates to a vehicle door lock device.

### BACKGROUND DISCUSSION

JP2012-92631A (Reference 1) discloses a configuration of a latch mechanism of a vehicle door lock device. The latch mechanism of the vehicle door lock device disclosed in Reference 1 includes a latch, a pawl, and a lift lever.

When a door is closed, the latch is pushed by a striker to rotate and is urged by a latch spring toward a return position. The pawl is supported to be rotatable together with the lift lever via a support shaft. The pawl is urged by a pawl spring toward a return position. The pawl engages with the latch at an engagement portion to prevent the latch from rotating to the return position.

With the lift lever rotating via a lock mechanism following a manipulation of either one of the outside door handle and an inside door handle provided in a door, the pawl rotates from a return position against an urging force of a pawl spring, and an engagement with the latch is released.

In the latch, a door reaction force that is a force to open a door that acts through a striker. When the door reaction force is strong, the manipulation force, needed to manipulate each of the outside door handle and the inside door handle, for releasing the engagement between the pawl and the latch increases, so that opening the door becomes difficult.

Thus, a need exists for a vehicle door lock device which is not susceptible to the drawback mentioned above.

### SUMMARY

A vehicle door lock device according to an aspect of this disclosure includes a latch, a pawl, a pawl lever, a lift lever, and an open link. The latch is provided so as to rotate between a full-latch position where a vehicle door is retained in a fully closed state by an engagement with a striker attached to a vehicle body, a half-latch position where the vehicle door is retained in a half door state by an engagement with the striker, and an unlatch position where the striker does not engage with the latch. The pawl is provided so as to rotate between a state where rotating in a direction to release an engagement of the latch with the striker is regulated by an engagement with the latch in the half-latch position, and a state where the latch does not engage with the pawl. The pawl lever is provided so as to rotate between a state where rotating in a direction to release an engagement of the latch with the striker is regulated by an engagement with the latch in the full-latch position and a state where the latch does not engage with the pawl lever. The lift lever rotates with the pawl integrally. The open link is provided to be capable of pushing the lift lever by being operated due to manipulation of a manipulation portion provided in the vehicle door. The pawl lever rotates by being pushed at a position to be pushed, by driving of the open link. The distance between the position to be pushed of the pawl lever and a rotation axis of the pawl lever is longer than a distance between the engagement position with the latch in the pawl lever and the rotation axis of the pawl lever.

### BRIEF DESCRIPTION OF THE DRAWINGS

The foregoing and additional features and characteristics of this disclosure will become more apparent from the following detailed description considered with the reference to the accompanying drawings, wherein:

FIG. 1 is a rear view illustrating a full-latch state of a vehicle door lock device according to an embodiment disclosed here as viewed from the rear of the vehicle;

FIG. 2 is a front view illustrating a full-latch state of the vehicle door lock device according to the embodiment disclosed here as viewed from the front of the vehicle;

FIG. 3 is a rear view illustrating a state of the vehicle door lock device according to the embodiment disclosed here immediately prior to a release of the engagement between a latch and a pawl lever as viewed from the rear of the vehicle;

FIG. 4 is a front view illustrating a state of the vehicle door lock device according to the embodiment disclosed here immediately prior to a release of the engagement between a latch and a pawl lever as viewed from the front of the vehicle;

FIG. 5 is a rear view illustrating a state of the vehicle door lock device according to the embodiment disclosed here in which the engagement between the latch and the pawl lever is released as viewed from the rear of the vehicle;

FIG. 6 is a front view illustrating a state of the vehicle door lock device according to the embodiment disclosed here in which the engagement between the latch and the pawl lever is released as viewed from the front of the vehicle;

FIG. 7 is a rear view illustrating a state of the vehicle door lock device according to the embodiment disclosed here in which the latch is in a half-latch position as viewed from the rear of the vehicle; and

FIG. 8 is a graph illustrating a result of an experimental example.

### DETAILED DESCRIPTION

A vehicle door lock device according to an embodiment disclosed here will be described with reference to the drawings in the following. In the description below, identical or equivalent parts in the figures will be denoted by the identical numerals, and the description thereof will not be repeated. A vehicle door lock device mounted to a door on the front right side of the vehicle will be described in the embodiment.

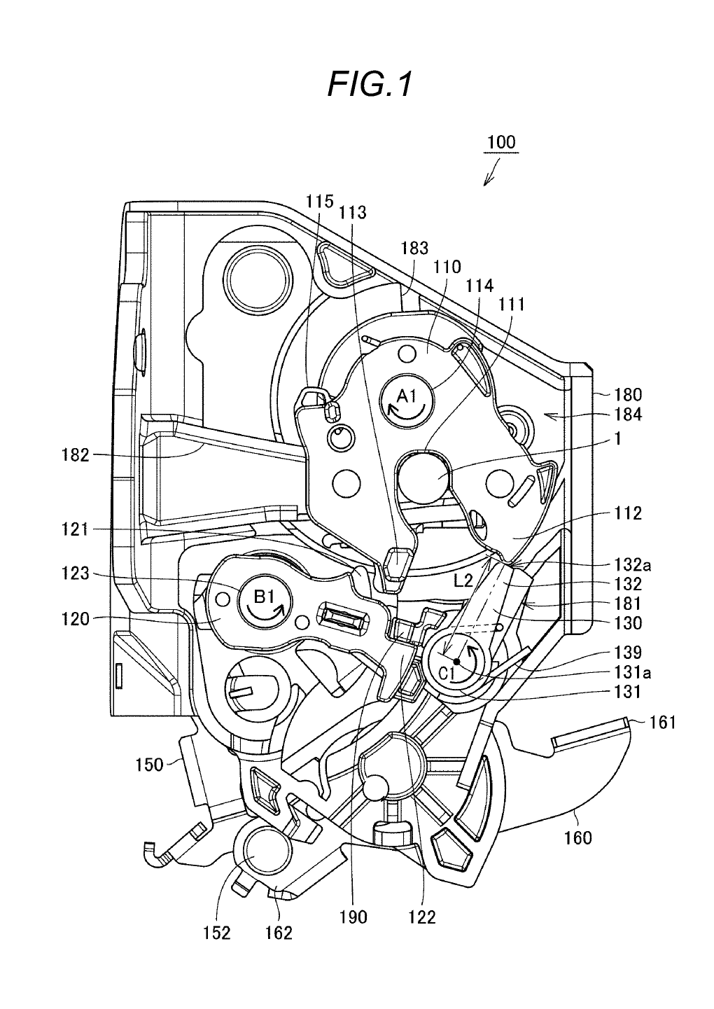

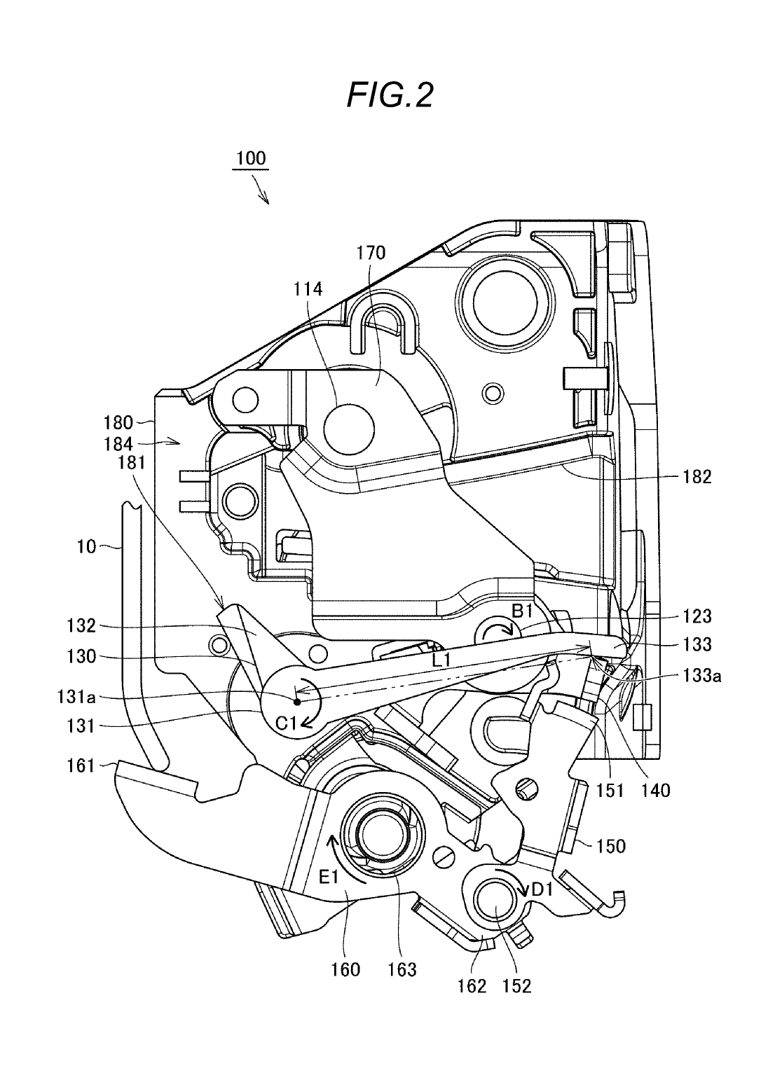

FIG. 1 is a rear view illustrating a full-latch state of a vehicle door lock according to an embodiment disclosed here as viewed from the rear of the vehicle. FIG. 2 is a front view illustrating a full-latch state of the vehicle door lock device according to the embodiment disclosed here as viewed from the front of the vehicle. In FIG. 1, a vehicle door lock device with a base plate removed is illustrated.

A vehicle door lock device 100 according to the embodiment disclosed here includes a metal latch 110, a metal pawl 120, a resin pawl lever 130, a steel plate lift lever 140, a steel plate open link 150, and a steel plate outside open lever 160 as illustrated in FIG. 1 and FIG. 2. The vehicle door lock device 100 further includes a steel plate base plate (not illustrated), a steel plate sub-base plate 170, a resin case 180, and a rubber stopper 190.

A base plate is attached to the rear side of the case 180 and a sub-base plate 170 is attached to the front side of the case 180. The case 180 includes a vertical wall portion 184 interposed between the base plate and the sub-base plate 170. The latch 110 and the pawl 120 are disposed on a rear side of the vertical wall portion 184. The stopper 190 is fixed onto the rear side of the vertical wall portion 184.

A latch support shaft 114 that rotatably supports the latch 110, a pawl support shaft 123 that rotates with the pawl 120 integrally, and a rotation shaft portion 131 of the pawl lever 130 are attached to the case 180. A through hole 181 through which a part of the pawl lever 130 is inserted, a striker insertion groove 182, and a locking portion 183 are provided in the case 180.

The striker insertion groove 182 is a groove that the striker 1 attached to the vehicle body advances on and retreats from relatively when the vehicle door is opened and closed, and is formed horizontally approximately at a center of the case 180. Also, a rubber cushion is installed at a blocking end portion of the striker insertion groove 182 so that a move-in of the striker 1 is accepted elastically. The locking portion 183 defines the unlatch position where the latch 110 does not engage with the striker 1.

The base plate is provided with a hole portion that axially supports the latch support shaft 114, a hole portion that axially supports the pawl support shaft 123, and a slit through which the striker 1 is inserted. The base plate is connected to the sub-base plate 170 via the latch support shaft 114 and the pawl support shaft 123.

The sub-base plate 170 is provided with a hole portion that axially supports the latch support shaft 114 and a hole portion that axially supports the pawl support shaft 123. The case 180 and the lift lever 140 are interposed between the sub-base plate 170 and the base plate.

The latch 110 is rotatably supported by the base plate and sub-base plate 170 via the latch support shaft 114. The latch 110 is urged in an A1 direction illustrated in FIG. 1 by a latch spring (not illustrated) installed coaxially on the latch support shaft 114. The latch 110 is pushed by the striker 1 to rotate against the urging force of the latch spring when the vehicle door is closed.

The latch 110 is provided so as to rotate between a full-latch position where the vehicle door is retained in a fully closed state by an engagement with the striker 1, a half-latch position where the vehicle door is retained in a half door state by an engagement with the striker 1, and an unlatch position where the striker 1 does not engage with the latch 110.

The latch 110 includes a striker retention groove 111 that engages with the striker 1 and a latch claw 112 that is adjacent to the striker retention groove 111. The striker retention groove 111 is a groove that engages in a sliding manner with the striker 1 that advances on and retreats from relatively when the vehicle door is opened and closed. The striker retention groove 111 retains the striker 1 in cooperation with the slit of the base plate. The latch claw 112 is positioned on the front side with respect to the striker retention groove 111 in a direction in which the latch 110 rotates when the latch 110 engages with the striker 1.

The latch 110 further includes the retention claw 113 adjacent to the striker retention groove 111 on the side opposite to the latch claw 112 and the portion to be locked 115. The retention claw 113 is positioned on the rear side with respect to the striker retention groove 111 in a direction in which the latch 110 rotates when the latch 110 engages with the striker 1. The portion to be locked 115 abuts against the locking portion 183 when the latch 110 is in the unlatch position. That is, when the latch 110 does not engage with the striker 1, the latch 110 rotates by the urging force of the latch spring in the A1 direction until the portion to be locked 115 abuts against the locking portion 183.

The pawl 120 is supported by the base plate and the sub-base plate 170 to rotate integrally with the lift lever 140 via the pawl support shaft 123. The pawl 120 is urged in a B1 direction illustrated in FIG. 1 and FIG. 2 by the pawl spring (not illustrated) installed coaxially on the pawl support shaft 123. With the lift lever 140 being pushed, the pawl 120 rotates against the urging force of the pawl spring.

The pawl 120 is provided so as to rotate between a state where rotating in a direction to release an engagement of the latch 110 with the striker 1 is regulated by an engagement with the latch 110 in the half-latch position, and a state where the latch 110 does not engage with the pawl 120.

The pawl 120 includes an engagement portion 121 and an extension portion 122. The engagement portion 121 is provided in a position where the engagement portion 121 can engage with the latch claw 112 of the latch 110 in the half-latch position. When the engagement portion 121 and the latch claw 112 are engaged with each other, rotating in a direction (A1 direction) to release an engagement of the latch 110 with the striker 1 is regulated.

The extension portion 122 is provided in a position where abutting against the stopper 190 is possible. When the lift lever 140 is not pushed, the pawl 120 rotates in the B1 direction by the urging force of the pawl spring until the extension portion 122 abuts against the stopper 190.

The pawl lever 130 includes a rotation shaft portion 131, a short piece portion 132 that extends from one end side of the rotation shaft portion 131 in a shaft direction to a radial direction of the rotation shaft portion 131, and a long piece portion 133 that extends from an other end side of the rotation shaft portion 131 in the shaft direction to the radial direction of the rotation shaft portion 131. When viewed from the shaft direction of the rotation shaft portion 131, an extension direction of the short piece portion 132 and the extension direction of the long piece portion 133 are substantially orthogonal to each other. The rotation shaft portion 131 is rotatably supported by the case 180. The short piece portion 132 is disposed through the through hole 181 of the case 180.

The pawl lever 130 is urged in a C1 direction illustrated in FIG. 1 and FIG. 2 by a spring 139 which is installed coaxially on the rotation shaft portion 131. The pawl lever 130 rotates against the urging force of the spring 139 by being pushed at a position 133a to be pushed positioned at a tip end of the long piece portion 133 is pushed from the lift lever 140.

The pawl lever 130 is provided so as to rotate between a state where the pawl lever 130 regulates rotating in the direction (A1 direction) in which the pawl lever 130 engages with the latch claw 112 of the latch 110 in the full-latch position to release engagement of the latch 110 with the striker 1 and a state where the latch 110 does not engage with the pawl lever 130. The pawl lever 130 engages with the latch claw 112 in an engagement position 132a of the short piece portion 132.

The position 133a to be pushed of the pawl lever 130 and the engagement position 132a of the pawl lever 130 are positioned on the sides opposite to each other with respect to the vertical wall portion 184 of the case 180. That is, the position 133a to be pushed is positioned on the front side of the vertical wall portion 184, and the engagement position 132a is positioned on the rear side of the vertical wall portion 184.

A distance L1 between the position 133a to be pushed of the pawl lever 130 and a shaft center 131a of the rotation shaft portion 131 of the pawl lever 130 is longer than a distance L2 between the engagement position 132a in the pawl lever 130 which engages with the latch 110 and the shaft center 131a of the rotation shaft portion 131 of the pawl lever 130.

The lift lever 140 is installed on the pawl support shaft 123. The lift lever 140 rotates via a lock mechanism following a manipulation of either one of the outside door handle and an inside door handle which are manipulation portions provided in a vehicle door.

The open link 150 is provided so as to rotate between a lock position and an unlock position. The open link 150 is rotatably supported by the support shaft 152 protruding from the outside open lever 160. An open link spring (not illustrated) is provided between the support shaft 152 and the open link 150. The open link spring urges the open link 150 toward the unlock position in a D1 direction illustrated in FIG. 2.

When the open link 150 is in the unlock position, a tip end portion 151 of the open link 150 faces the lift lever 140, and the open link 150 is provided so as to push the lift lever 140. As will be described later, the open link 150 operates by the manipulation of the manipulation portion provided in the vehicle door.

The outside open lever 160 is rotatably supported by a rotation shaft 163 attached to the case 180. The outside open lever 160 is provided so as to rotate between the push position in which the open link 150 is pushed and the non-push position in which the open link 150 is not pushed.

The outside open lever 160 includes one end portion 161 and other end portion 162 positioned on the sides opposite to each other with respect to the rotation shaft 163. The one end portion 161 of the outside open lever 160 is connected to the outside handle via a rod 10. The support shaft 152 is provided to protrude from the other end portion 162 of the outside open lever 160.

The outside open lever 160 is urged by the open lever spring, installed coaxially on the rotation shaft 163 in an E1 direction illustrated in FIG. 2. With the one end portion 161 being pushed from the rod 10, the outside open lever 160 rotates from the non-push position to push position against the urging force of the open lever spring.

The outside open lever 160 operates by a manipulation of the outside handle provided in the vehicle door and drives the open link 150 to push the lift lever 140 by the open link 150.

Specifically, when the outside handle is in an initial position, the outside open lever 160 is positioned in the non-push position. At this time, the outside open lever 160 exerts no force on the open link 150.

When the outside handle moves from the initial position to the latch release position, the outside open lever 160 rotates to the push position. In a case where the outside open lever 160 rotates to the push position when the open link 150 is in the unlock position, the outside open lever 160 pushes the open link 150 and drives the open link 150. The driven open link 150 pushes the lift lever 140 to rotate by the tip end portion 151.

The pawl lever 130 rotates by being pushed at the position 133a to be pushed, by driving of the open link 150. In the embodiment, the pawl lever 130 rotates when the position 133a to be pushed is pushed by the lift lever 140 that is pushed by the open link 150. The pawl lever 130 may be configured to rotate when the position 133a to be pushed is pushed by the open link 150 directly.

The open link 150 is also driven by the inside open lever (not illustrated) linked with the inside handle by a manipulation wire. The inside open lever is provided so as to rotate between the push position in which the open link 150 is pushed and the non-push position in which the open link 150 is not pushed.

The inside open lever is operated by the manipulation of the inside handle provided in the vehicle door, and pushes the outside open lever 160. The outside open lever 160, pushed by the inside open lever, drives the open link 150 by pushing, and the open link 150 pushes the lift lever 140.

Specifically, when the inside handle is positioned in the initial position, the inside open lever is positioned in the non-push position. At this time, the inside open lever exerts no force on the open link 150.

In a case where the inside handle moves from the initial position to the latch release position, the inside open lever moves to the push position. In a case where the inside open lever moves to the push position when the open link 150 is in the unlock position, the inside open lever pushes the open link 150 via the outside open lever 160 and drives the open link 150.

In the following, the operation will be described when the vehicle door lock device 100 according to the embodiment shifts from the full-latch state to the unlatch state. In the description of the operation below, a case where the open link 150 is driven by manipulating the outside handle and the latch 110 is rotated will be described. However, even in a case where the open link 150 is driven by manipulating the inside handle and the latch 110 rotates, the following operation of the open link 150 is the same.

As illustrated in FIG. 1 and FIG. 2, when the vehicle door lock device 100 according to the embodiment is in the full-latch state, the latch claw 112 of the latch 110 and the engagement position 132a of the short piece portion 132 of the pawl lever 130 engage with each other, and the latch 110 is positioned in the full-latch position with a rotating in a direction (A1 direction) to release the engagement with the striker 1 being regulated. At this time, the engagement portion 121 of the pawl 120 and the retention claw 113 of the latch 110 are separated from each other. And the pawl 120 is not engaged with the latch 110.

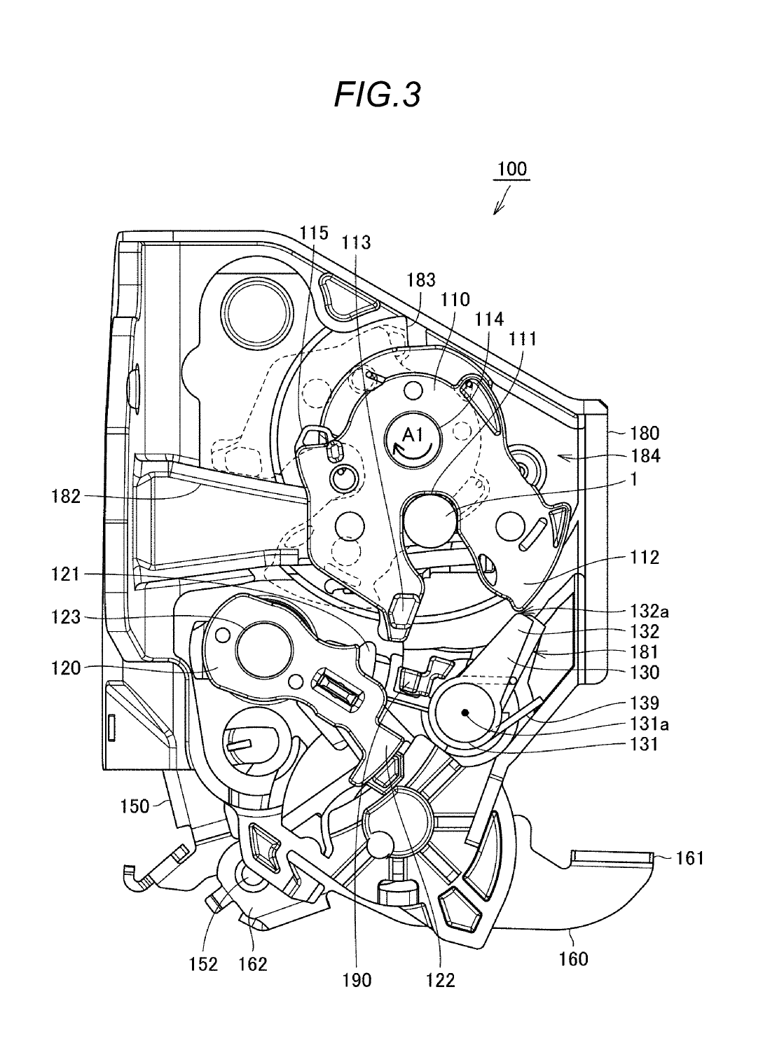

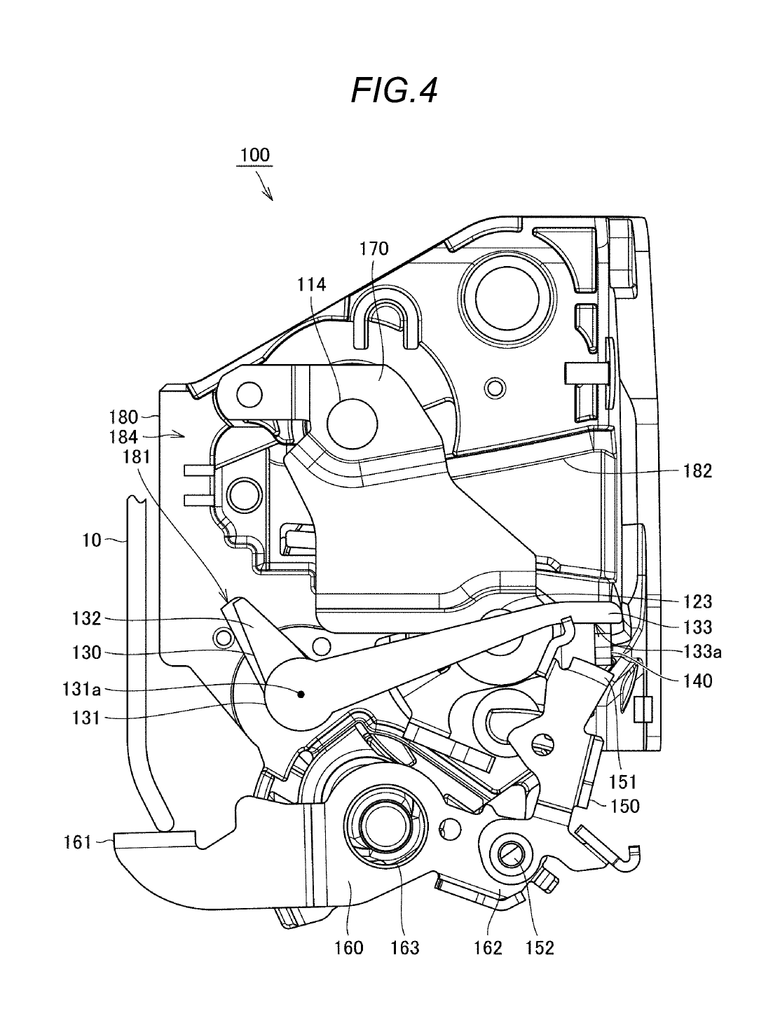

FIG. 3 is a rear view illustrating a state of the vehicle door lock device according to the embodiment immediately prior to a release of the engagement between a latch and a pawl lever as viewed from the rear of the vehicle. FIG. 4 is a front view illustrating a state of a vehicle door lock device according to the embodiment disclosed here immediately prior to a release of the engagement between a latch and a pawl lever as viewed from the front of the vehicle.

FIG. 3 illustrates the vehicle door lock device in a state where the base plate is removed. FIG. 3 illustrates the latch 110 denoted with a dotted line positioned in the unlatch position with the engagement between the latch 110 and the pawl lever 130 being released.

In a case where the outside handle is manipulated to move from the initial position toward a latch release position, as illustrated in FIG. 3 and FIG. 4, with the one end portion 161 being pushed by the rod 10, the outside open lever 160 rotates from the non-push position toward the push position.

With the outside open lever 160 rotating to the push position, the lift lever 140 is pushed to rotate by the tip end portion 151 of the open link 150. Following the rotating of the lift lever 140, the pawl 120 rotates in a direction such that the extension portion 122 is separated from the stopper 190. As a result, the engagement portion 121 of the pawl 120 moves to a position where the latch claw 112 of the latch 110 does not engage.

With the lift lever 140 rotating, the position 133a to be pushed of the long piece portion 133 is pushed from the lift lever 140, and the pawl lever 130 rotates against the urging force of spring 139. As a result, the tip end of the short piece portion 132 of the pawl lever 130 moves in a direction separated from the latch claw 112 of the latch 110 while sliding in contact with the latch claw 112.

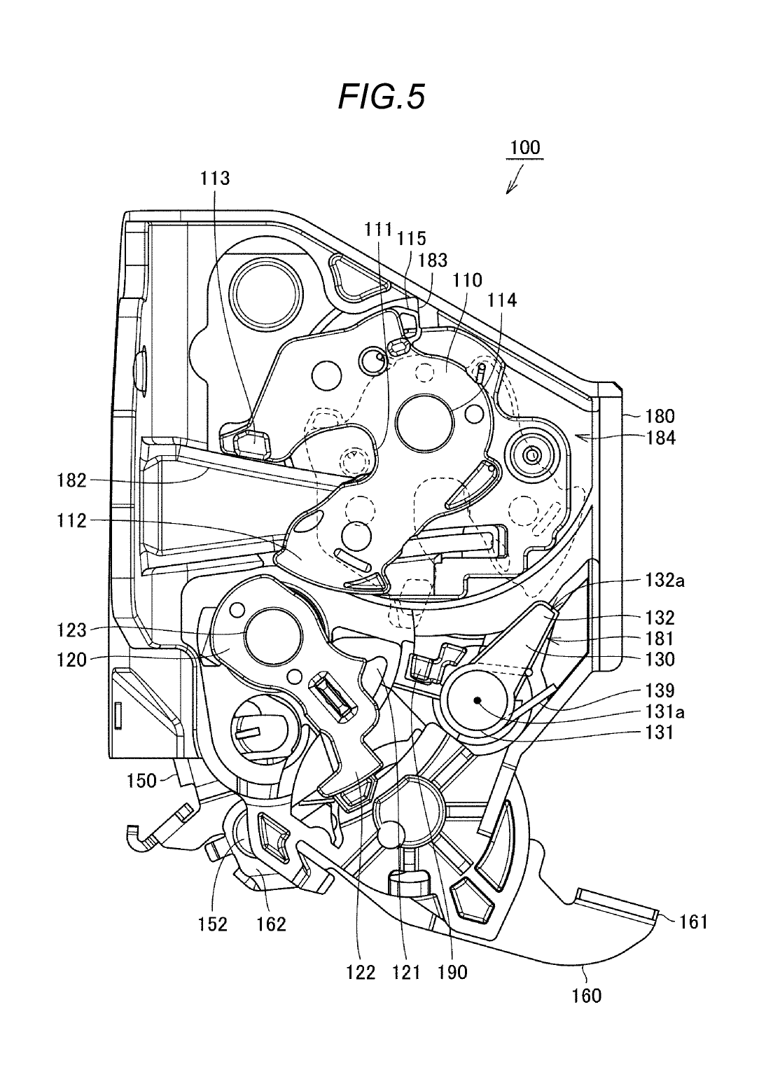

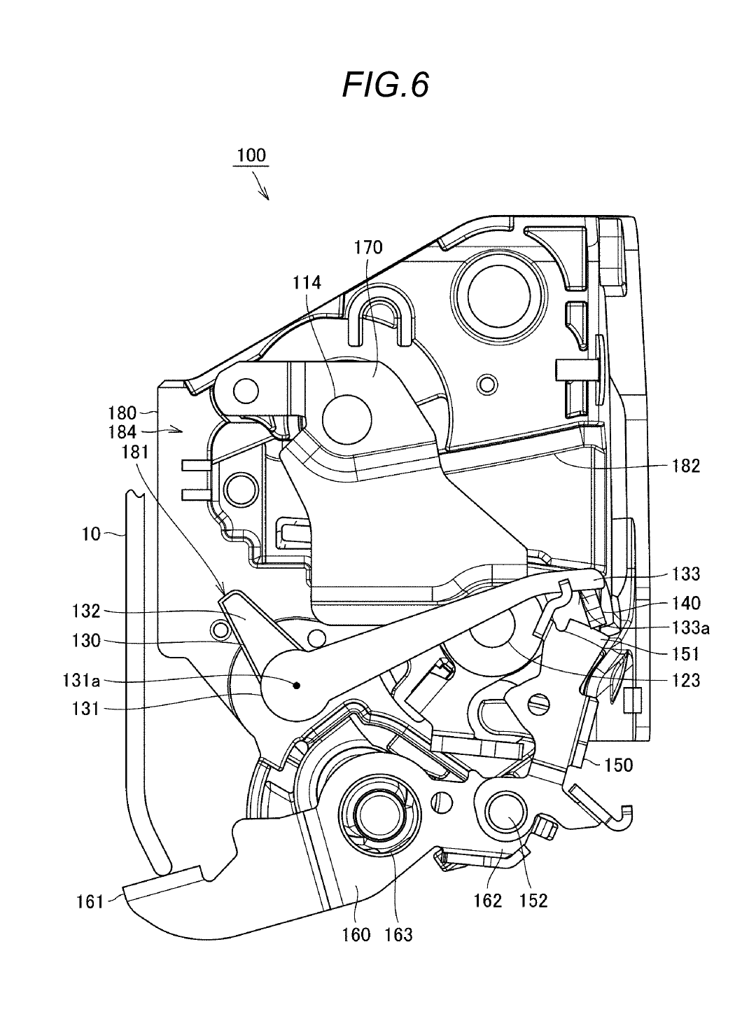

FIG. 5 is a rear view illustrating a state of the vehicle door lock device according to the embodiment disclosed here in which the engagement between the latch and the pawl lever is released as viewed from the rear of the vehicle. FIG. 6 is a front view illustrating a state of the vehicle door lock device according to the embodiment disclosed here in which the engagement between the latch and the pawl lever is released as viewed from the front of the vehicle.

FIG. 5 illustrates the vehicle door lock device in a state where the base plate is removed. Also, FIG. 5 illustrates the latch 110 denoted with a dotted line positioned in a latch position before the engagement between the latch 110 and the pawl lever 130 is released.

When the outside handle is manipulated to be positioned in the latch release position, as illustrated in FIG. 5 and FIG. 6, the outside open lever 160 is positioned in the push position. In this state, the tip end of the short piece portion 132 of the pawl lever 130 is separated from the latch claw 112 of the latch 110, and the engagement between the pawl lever 130 and the latch 110 is released. As a result, the latch 110 rotates by the urging force of the latch spring until the portion to be locked 115 abuts against the locking portion 183 and is positioned in an unlatch position.

As described above, the vehicle door lock device 100 shifts from the full-latch state to the unlatch state. In the vehicle door look device 100 according to the embodiment, the latch 110 is positioned in a half-latch position when the vehicle door is in a half door state.

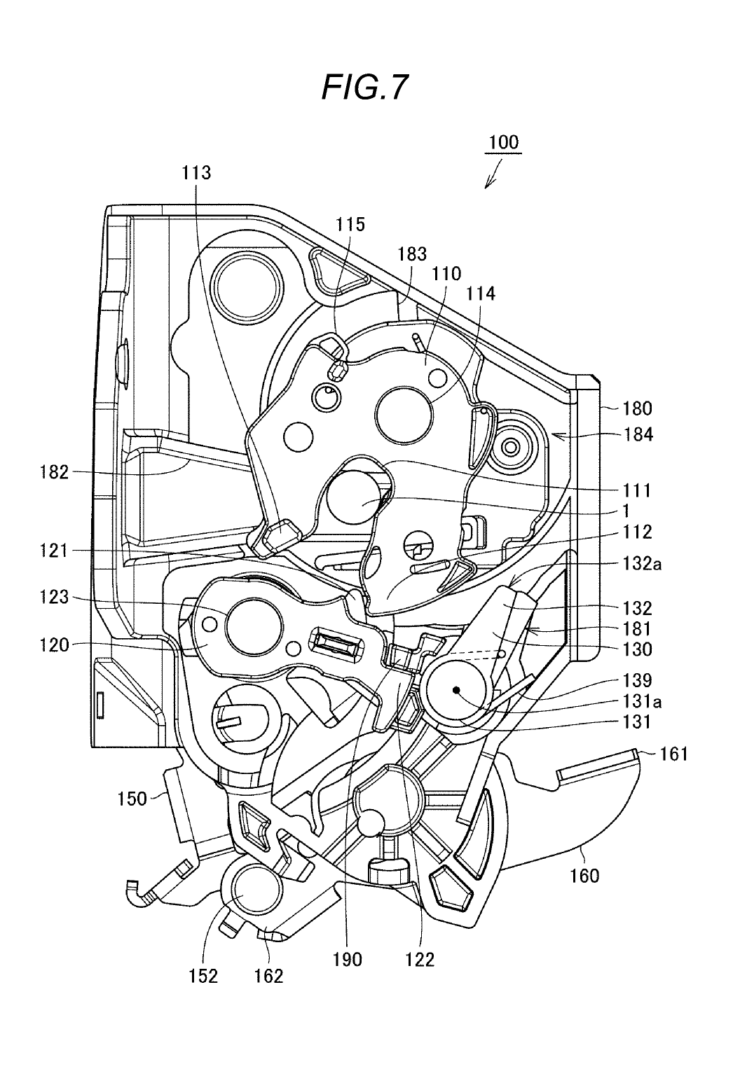

FIG. 7 is a rear view illustrating a state of the vehicle door lock device according to the embodiment disclosed here in which the latch is in a half-latch position as viewed from the rear of the vehicle. FIG. 7 illustrates the vehicle door lock device in a state where the base plate is removed.

When the door is in a half door state, as illustrated in FIG. 7, the extension portion 122 of the pawl 120 abuts against the stopper 190. The engagement portion 121 of the pawl 120 regulates rotating in a direction in which the engagement portion 121 engages with the latch claw 112 of the latch 110 to release the engagement of the latch 110 with the striker 1. In this way, the vehicle door is retained in a half door state.

In the vehicle door lock device 100 according to the embodiment, the distance L1 between the position 133a to be pushed of the pawl lever 130 and the shaft center 131a of the rotation shaft portion 131 of the pawl lever 130 is longer than the distance L2 between the engagement position 132a with the latch 110 in the pawl lever 130 and the shaft center 131a of the rotation shaft portion 131 of the pawl lever 130.

In this way, it is possible to reduce the driving force of the open link 150 needed to drive the open link 150 and make the pawl lever 130 rotate thereby. Specifically, if a force, which is applied to the engagement position 132a to make the pawl lever 130 rotate so that the engagement between the engagement position 132a of the short piece portion 132 and the latch claw 112 of the latch 110 is released, is F, and a driving force, which is applied from the open link 150 to the position 133a to be pushed of the long piece portion 133 of the pawl lever 130, is M, then, the relation of F×L2=M×L1 is satisfied. Therefore, the smaller the L2/L1 is, the smaller the driving force M of the open link 150 can be made.

The driving force M of the open link 150 is a force transmitted to the open link 150 via the rod 10 and the outside open lever 160 by the manipulation force in manipulating the outside handle. Therefore, the manipulation force needed to manipulate the outside handle can be reduced by reducing the driving force M.

Similarly, the driving force M of the open link 150 is a force transmitted to the open link 150 via a manipulation wire and the inside open lever by the manipulation force in manipulating the inside handle. Therefore, the manipulation force needed to manipulate the inside handle can be reduced by reducing the driving force M.

Therefore, the vehicle door lock device 100 according to the embodiment can suppress an increase in the manipulation force, needed to manipulate the handle, caused by the increased door reaction force, and thereby stable opening of a door is made possible. That is, even when the door reaction force increases, the door can be opened easily by manipulating the handle with a relatively small manipulation force.

Here, an experimental example will be described, where an experiment is performed on a relation between the door reaction force and the manipulation force needed to manipulate the handle in the vehicle door lock device 100 according to the embodiment and in a vehicle door lock device, for the purpose of comparison, which is not provided with the pawl lever 130 and where engagement portion of the pawl engages with the retention claw of the latch when the vehicle door lock device is in a full-latch state.

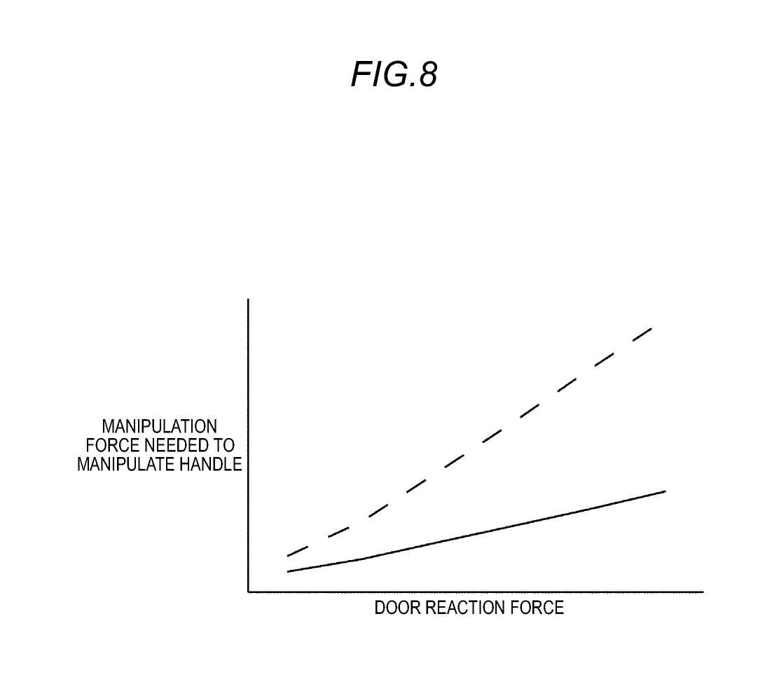

FIG. 8 is a graph illustrating the result of this experimental example. In FIG. 8, the horizontal axis represents the door reaction force, and the vertical axis represents the manipulation force needed to manipulate the handle. In FIG. 8, a solid line denotes data of the vehicle door lock device 100 according to the embodiment, and a dotted line denotes data of the vehicle door lock device in the comparison example.

As illustrated in FIG. 8, compared with the vehicle door lock device in the comparison example, the vehicle door lock device 100 according to the embodiment can suppress the increase in the manipulation force, caused by the increased door reaction force, needed to manipulate the handle by ⅔. The experiment result confirms that the vehicle door lock device 100 according to the embodiment can suppress the increase in the manipulation force needed to manipulate the handle caused by the increased door reaction force, and thus, the stable opening of a door is made possible.

In the vehicle door lock device 100 according to the embodiment, the latch claw 112 is positioned on the front side with respect to the striker retention groove 111 in a direction in which the latch 110 rotates when the latch 110 engages with the striker 1, and the pawl lever 130 engages with the latch claw 112 of the latch 110 in the full-latch position. In this way, the latch 110, the pawl 120, and the pawl lever 130 can be disposed adjacent to one another, so that provision of the pawl lever 130 can prevent the vehicle door lock device 100 from becoming large.

However, the embodiment disclosed here is not limited to a case where the pawl lever 130 engages with the latch claw 112 of the latch 110 in the full-latch position. The disclosure may also include a structure where the pawl lever 130 engages with the retention claw 113 of the latch 110 in the full-latch position.

In the vehicle door lock device 100 according to the embodiment, the pawl lever 130 rotates by the position 133a to be pushed being pushed by the lift lever 140 that is pushed by the open link 150. In this way, the pawl lever 130 rotates following the rotating of the lift lever 140, and thus, it is possible to synchronize the rotation of the pawl 120 with the rotation of the pawl lever 130, and it is possible for the latch 110 to switch among the full-latch position, the half-latch position, and the unlatch position with stability.

In the vehicle door lock device 100 according to the embodiment, the position 133a to be pushed of the pawl lever 130 and the engagement position 132a of the pawl lever 130 are positioned on the sides opposite to each other with respect to the case 180. In this way, engagement with each of the latch 110 and the lift lever 140 by the pawl lever 130 of a single member becomes possible. As a result, the increase in the manipulation force, needed to manipulate the handle, caused by the increased door reaction force can be reduced with the simple configuration.

In the vehicle door lock device 100 according to the embodiment, the pawl lever 130 is made of a resin. In this way, the pressure on the surface where the pawl lever 130 and the latch 110 come into contact with each other can be reduced. Further, resistance against sliding between the pawl lever 130 and the latch 110 can be lowered. As a result, it is possible to reduce the force F itself to be applied to the engagement position 132a to make the pawl lever 130 rotate so that the engagement between the engagement position 132a of the short piece portion 132 and the latch claw 112 of the latch 110 is released. In this way, an increase in the manipulation force needed to manipulate the handle caused by the increased door reaction force can be suppressed.

However, the embodiment disclosed here is not limited to a case where the pawl lever 130 is made of resin. The surface of a metal base may be covered with a resin, or the pawl lever 130 may be made of a metal.

A vehicle door lock device according to an aspect of this disclosure includes a latch, a pawl, a pawl lever, a lift lever, and an open link. The latch is provided so as to rotate between a full-latch position where a vehicle door is retained in a fully closed state by an engagement with a striker attached to a vehicle body, a half-latch position where the vehicle door is retained in a half door state by an engagement with the striker, and an unlatch position where the striker does not engage with the latch. The pawl is provided so as to rotate between a state where rotating in a direction to release an engagement of the latch with the striker is regulated by an engagement with the latch in the half-latch position, and a state where the latch does not engage with the pawl. The pawl lever is provided so as to rotate between a state where rotating in a direction to release an engagement of the latch with the striker is regulated by an engagement with the latch in the full-latch position and a state where the latch does not engage with the pawl lever. The lift lever rotates with the pawl integrally. The open link is provided to be capable of pushing the lift lever by being operated due to manipulation of a manipulation portion provided in the vehicle door. The pawl lever rotates by being pushed at a position to be pushed, by driving of the open link. The distance between the position to be pushed of the pawl lever and a rotation axis of the pawl lever is longer than a distance between the engagement position with the latch in the pawl lever and the rotation axis of the pawl lever.

In the aspect of this disclosure, the pawl lever may rotate by being pushed at the position to be pushed, by the lift lever pushed by the open link.

In the aspect of this disclosure, the latch may include a striker retention groove that engages with the striker and a latch claw that is adjacent to the striker retention groove. The latch claw may be positioned on a front side with respect to the striker retention groove in a direction in which the latch rotates when the latch engages with the striker. The pawl lever may engage with the latch claw of the latch in the full-latch position.

In the aspect of this disclosure, the vehicle door lock device may further include a case that rotatably supports the pawl lever. The position to be pushed of the pawl lever and the engagement position of the pawl lever may be positioned on sides opposite to each other with respect to the case.

In the aspect of this disclosure, the pawl lever may be made of a resin.

According to the aspect of this disclosure, it is possible to stably open a door by suppressing an increase in the manipulation force, needed to manipulate the handle, caused by the increased door reaction force.

It should be noted that an embodiment disclosed here is an example in all respects and is not limited thereto. The scope of the disclosure is defined by the scope of claims, not by the above descriptions, and the intention is to include meanings equivalent to the claims and all of the modifications within the scope.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

What is claimed is:

1. A vehicle door lock device comprising:
a latch that is provided so as to rotate between a full-latch position where a vehicle door is retained in a fully closed state by an engagement with a striker attached to a vehicle body, a half-latch position where the vehicle door is retained in a half door state by the engagement with the striker, and an unlatch position where the striker does not engage with the latch;
a pawl that is provided so as to rotate between a state where rotating in a direction to release the engagement of the latch with the striker is regulated by an engagement with the latch in the half-latch position, and a state where the latch does not engage with the pawl;
a pawl lever that is provided so as to rotate between a state where rotating in a direction to release the engagement of the latch with the striker is regulated by an engagement with the latch in the full-latch position and a state where the latch does not engage with the pawl lever;
a lift lever that rotates with the pawl integrally; and
an open link that is provided to be capable of pushing the lift lever by being operated due to manipulation of a manipulation portion provided in the vehicle door,
wherein, the pawl lever rotates by being pushed at a position to be pushed, by driving of the open link; and
a distance between the position to be pushed of the pawl lever and a rotation axis of the pawl lever is longer than a distance between the engagement position with the latch in the pawl lever and the rotation axis of the pawl lever.

2. The vehicle door lock device according to claim 1,
wherein, the pawl lever rotates by being pushed at the position to be pushed, by the lift lever pushed by the open link.

3. The vehicle door lock device according to claim 1,
wherein the latch includes a striker retention groove that engages with the striker and a latch claw that is adjacent to the striker retention groove,
the latch claw is positioned on a front side with respect to the striker retention groove in a direction in which the latch rotates when the latch engages with the striker, and
the pawl lever engages with the latch claw of the latch in the full-latch position.

4. The vehicle door lock device according to claim 1, further comprising:
a case that rotatably supports the pawl lever,
wherein the position to be pushed of the pawl lever and the engagement position of the pawl lever are positioned on sides opposite to each other with respect to the case.

5. The vehicle door lock device according to claim 1,
wherein the pawl lever is made of a resin.
